(19) United States
(12) Patent Application Publication
(10) Pub. No.: US 2023/0418279 A1
(43) Pub. Date: Dec. 28, 2023

(54) PREDICTIVE MAINTENANCE FOR TERMINALS

(71) Applicant: NCR Corporation, Atlanta, GA (US)

(72) Inventors: Kun Zhu, Smyrna, GA (US); Rajendra Prasad Chepuri, Hyderabad (IN); Laxmi Rohith Madupu, Hyderabad (IN)

(21) Appl. No.: 17/846,238

(22) Filed: Jun. 22, 2022

(51) Int. Cl. G05B 23/02

(52) U.S. Cl. CPC G05B 23/0283; G05B 23/0254; G05B 23/0227; G05B 23/027

(57) ABSTRACT

Multiple types of machine learning models (MLMs) are trained on training data to provide predictions of terminal failures. The MLMs are tested on testing data and prediction scores are calculated for the MLMs based on the testing. An MLM having a highest prediction score is selected and deployed to a production environment for a current period of time to provide predictions of terminal failures. Current terminal data is provided as input to the deployed MLM, and the MLM's predictions are provided to an interface, system, or service of the production environment. The current terminal data is also provided to the non-selected MLMs, which generate candidate predictions during the current period of time. At the end of the current period of time, prediction scores of the selected and non-selected MLMs are calculated. A next MLM is selected for a next period of time for deployment based on the prediction scores.

### BACKGROUND

Self-Checkout (SCO) lanes in retail stores allow customers to shop and checkout items at Self-Service Terminals (SSTs) at their own convenience without having to interact with store associates. SSTs were introduced in the industry to save on labor costs and reduce theft. Failure of an SST/SCO not only disrupts a shopper's experience, but also reduces the store's productivity owing to the intervention that may be needed to address the failure.

Customer SCO usage has increased substantially since the beginning of the COVID-19 pandemic, with health-related concerns accelerating the shift in customer preferences away from Point-Of-Sale (POS) cashier-assisted terminals towards SCOs. With this increase in SCO customer adoption, failures are also on the rise, resulting in increased costs for retailers and increased customer dissatisfaction, which in turn, can translate into decreased customer loyalty.

When an SCO is offline, longer customer queues typically form at the remaining SCOs and/or at already minimally-staffed POS lanes. This can lead to a potential increase in the failure rate of the remaining SCOs due to the increased usage they receive. In addition, SCO failure can lead some customers to opt out of their purchase altogether (resulting in lost revenue to the retailer) and/or visit a different retailer for their next purchase (resulting in a loss of recurring revenue).

Additionally, depending upon the reason for a SCO failure, a specialized service technician may be needed to resolve the issue, which could lead to days or even weeks of delay before the SCO is back online for customer use. Moreover, the store's staff may only be trained to handle a specific set of failures, and thus, even for a minor SCO failure, the store may not have staff members on-site with the correct skillset to resolve the issue and may have to call on a specific staff member with the requisite skillset to come into the store to resolve the issue. This can lead to extended SCO downtime. Furthermore, even if a staff member capable of resolving a failure is on-site, the staff member may be engaged in another task, such as operating a POS lane. As such, a store may need to temporarily suspend operation of a POS lane while the staff member resolves the SCO issue.

### SUMMARY

According to example embodiments, a method and a system for predictive maintenance on SSTs are disclosed. Specifically, in an example embodiment, multiple types of machine learning models (MLMs) are trained on training terminal data to provide predictions associated with failures and non-failures of terminals. Each MLM is then tested on testing terminal data and a score for predicting failures/non-failures is calculated for each MLM based on testing. A given MLM having the highest score can then be selected. The selected MLM may be deployed to a production environment to provide real-time failure predictions for the terminals using current terminal data.

### BRIEF DESCRIPTION OF THE DRAWINGS

FIG. 1 is a diagram of a system for predictive maintenance on terminals, according to an example embodiment.

FIG. 2 is a diagram of a method of predictive maintenance on terminals, according to an example embodiment.

FIG. 3 is a diagram of another method of predictive maintenance on terminals, according to an example embodiment.

### DETAILED DESCRIPTION

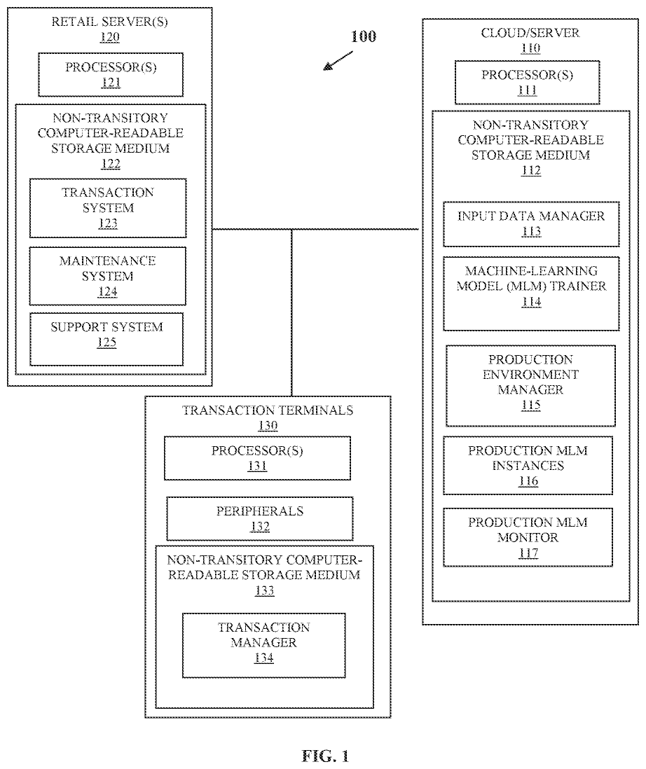

FIG. 1 is a diagram of a system 100 for predictive maintenance on terminals, according to an example embodiment. The system 100 is shown schematically in greatly simplified form, with only those components relevant to understanding of one or more embodiments (represented herein) being illustrated. The various components are illustrated, and the arrangement of the components is presented for purposes of illustration only. It is to be noted that other arrangements with more or less components are possible without departing from the predictive maintenance on terminals teachings presented herein and below.

Moreover, various components are implemented as one or more software modules, which reside in non-transitory storage and/or hardware memory as executable instructions. The executable instructions, when executed by one or more hardware processors accessing the non-transitory computer-readable storage medium, cause the one or more processors to perform the processing discussed herein and below.

In example embodiments of the disclosed technology, system 100 provides proactive, adaptive, and data-driven predictions for maintenance for terminals. In an example embodiment, the system 100 collects terminal data from a variety of different sources (such as transaction terminals, a transaction system, a support system, and the like) and processes the collected data through a first pipeline and/or a first set of workflows, where features presented in the terminal data are identified and labeled. The labeled feature data is then passed to a machine learning model (MLM) trainer as part of a second pipeline and/or a second set of workflows, where the system 100 trains multiple different types of MLMs on the labeled feature data to predict outcomes associated with service incidents on the terminals. The system 100 then compares the predicted outcomes to known outcomes associated with the service incidents to determine a respective score for each MLM. The different types of MLMs may include different machine learning models that fall within a same class of machine learning algorithms (e.g., different types of supervised learning algorithms) and/or machine learning models that fall within different algorithm classes (e.g., a supervised learning algorithm and an unsupervised learning algorithm).

The system 100 may track the prediction score across the different types of MLMs for at least a portion of the training data and may select the MLM having the highest prediction score to provide production level terminal maintenance predictions for a future period of time. In example embodiments, the selected MLM instance may then be deployed to a production environment for a given retailer associated with the terminal data. During a current period of time, feature labeling may be performed on live terminal data and the labeled data may be fed directly to the MLM instance within the production environment. Predictions may then be provided through an interface or through an existing maintenance system of the retailer to address predictive maintenance issues on the terminals before the terminals encounter issues.

In some embodiments, each of the various types of MLMs may be fed the featured labeled live terminal data during the current period of time, but only the current production MLM instance may be used to supply predictions to the retailer during the current period of time. In example embodiments, actual results associated with failing terminals are monitored during the current period of time and compared against the predictions from the production MLM instance and the other types of MLMs previously trained but not selected for the production environment. At the end of the current period of time, the production MLM instance can be switched to one of the other types of MLMs if, for example, one of the other types of MLMs had a better prediction score at the end of the current period of time. That is, the MLM instance having the highest prediction score at the end of the current period (which may be the same MLM currently in the production environment or a different one) may then be selected for the production environment in the next period of time. The selected MLM instance may then be retrained on a next set of most-recent labeled data and released to the production environment to provide the predictions to the retailer during the next period of time. This process may continue such that during any given current period of time, the MLM instance with the highest prediction score during the last or most recently passed period of time is used in the production environment for the current period of time. This yields a technical effect in the form of dynamic adaptation to the natural changes in patterns of the terminal data for the given retailer and ensures that an optimal MLM instance is providing the retailer with failure predictions for the terminals within the retailer's production environment for each current period of time.

As used herein, “a period of time” refers to an interval of time, such as 6 months, 3 months, 1 week, etc. An “interval of time” may be used herein synonymously and interchangeably with a “period of time.” A period of time is a configurable parameter that can be changed with the processing discussed herein and below. Also, a first period of time used for training an MLM, a second period of time used for testing a trained MLM, and a third period of time used for MLM predictions in a production environment may each be the same or different. For instance, the first and second periods of time may have the same duration, which may be longer than the third period of time.

A “transaction terminal” is a device that may include one or more peripherals, and which a customer may use to perform a transaction. The phrase “transaction terminal” may be used interchangeably and synonymously with the term “terminal.” A transaction terminal can be an SST or a POS terminal. An SST is generally used to perform self-directed transactions by a customer whereas a POS terminal is generally used to perform cashier/teller/agent-assisted transactions. A transaction may be an item purchase or return at a retail store, a check-in event for a travel or venue-related matter/service, or a financial-related event. Furthermore, an SST may be an Automated Teller Machine (ATM), a travel/venue kiosk, or a retail store SCO terminal.

The term “component” refers to any mechanical device forming part of a terminal or a peripheral device of a terminal. A component may be a sensor, a belt, a hopper, an infeed coin chute, an outfeed coin chute, an infeed paper-based media port, and outfeed paper-based media port, a media cassette, a transport path, a basket, a drive (motor), a print head, an illumination source, a media diverter, a scale, a lens, a spine, a loader, a media accepter, a media dispenser, a scanner window, a card port, etc. A peripheral device may be, by way of example only, a scanner, a weigh scale, a combined scanner-weigh scale, a basket scale, a camera, a microphone, a keypad, a touch display, a media depository, a media dispenser, a media recycler, a card reader, a printer, a cash drawer, a coin accepter, a coin dispenser, a coin recycler, etc.

A “prediction” as used herein refers to a forecasted/projected maintenance issue or failure for a terminal that is produced as output from a trained MLM based on input data features provided to the MLM. The prediction may be a data structure (e.g., a JavaScript Object Notation (JSON) object or the like) that includes a terminal identifier of a terminal that the MLM predicts as having a maintenance issue/failure; a failure type identifier that indicates the type of maintenance issue/failure (for example media depository, weigh scale, scanner, card reader, etc.); a projected calendar date, day of week, or elapsed number days from a current day that the terminal identified by the terminal identifier is projected to encounter the maintenance issue/failure; and/or a suggested remedial action to resolve the maintenance issue/failure (e.g., recalibrate a weigh scale, clean the scanner window, replenish a media depository with currency or specific currency denominations, etc.).

“Features” are at least portions of input data that are labeled within the input data as being potentially relevant to the MLM in deriving an algorithm that yields the prediction. Some features may be already present in the input data and may be labeled while other features may be added for the purposes of testing the MLMs (discussed herein and below).

Referring again to FIG. 1, system 100 includes a cloud/server 110, one or more retail server(s) 120, and transaction terminals 130. Cloud/Server 110 includes at least one processor 111 and a non-transitory computer-readable storage medium 112. Similarly, each retail server 120 includes at least one processor 121 and a non-transitory computer-readable storage medium 122. Medium 112 includes executable instructions for an input data manager 113, an MLM trainer 114, a production environment manager 115, production MLM instances 116, and a production MLM monitor 117. Responsive to obtaining or otherwise being provided with the executable instructions from medium 112, the processor 111 may execute the instructions to perform the operations discussed herein and below with respect to 113-117. Medium 122 includes executable instructions for a transaction system 123, a maintenance system 124, and a support system 125. Responsive to obtaining or otherwise being provided with the executable instructions from medium 122, the processor 121 may execute the instructions to perform the operations discussed herein and below with respect to 123-125.

In an embodiment, production environment manager 115 includes a web-based or mobile application user interface via which agents of a retailer can receive the predictions generated by the current production MLM instance 116 during the current period of time. The agents may access the user interface via a browser executable on a user device, such as desktop computer, laptop computer, smartphone, tablet device, or wearable device.

In example embodiments, each transaction terminal 130 includes at least one processor 131, peripheral devices (peripherals) 132, and a non-transitory computer-readable storage medium 133. Medium 133 includes executable instructions for a transaction manager 134. Responsive to obtaining or otherwise being provided with the executable instructions from medium 133, the processor 131 may execute the instructions to perform the operations discussed herein and below with respect to 134.

Input data manager 113 may include one or more independent processing modules organized in a workflow or pipeline, such that collected input data is received and processed within the pipeline. Application Programming Interfaces (APIs) may be leveraged for the purposes of obtaining terminal data from transaction system 123 and maintenance system 124. Input data manager 113 may collect real-time terminal data from transaction system 123, maintenance system 124, and support system 125 and may have access to historical transaction data associated with 123-125. Moreover, historical terminal data may be obtained from data stores and/or transaction logs. Terminal data may include event data generated by terminals 130 during transaction processing for transactions by transaction managers 134; maintenance or service intervention data on the terminals 130, as available from maintenance system 124; and/or support data on the terminals 130, as available from support system 125.

Maintenance or service intervention data may include data records for service engineers who were called or required to perform remedial actions on terminals 130. Support data includes data records associated with reported service tickets entered or raised for the terminals 130. The maintenance or service intervention data may include data relating to incident work orders that required service engineers to perform remedial actions/service on terminals 130. Support data may include data relating to service requests made to terminals 130.

Generally, there is a small likelihood that terminals 130 will fail during a store's operational hours. This means that the population of impaired terminals 130 may be significantly smaller than the population of their counterparts which function as expected. Thus, the terminal data is imbalanced and an MLM that is trained on such imbalanced terminal data may be unable to correctly classify faulty terminals without generating an undesirably high number of false positives.

However, when a failure does occur, the retailer typically incurs a substantial cost and disruption to its business operations. As a result, in some embodiments, input data manager 113 performs re-sampling on terminal data to generate more balanced training data for training the MLMs, where the training data includes a substantially equal number of training input records from the terminal data for failing terminals 130 as it does for non-failing terminals 130. The MLMs may then be trained on the balanced training data to yield trained models having improved prediction scores with respect to terminal failures.

After the terminal data is sampled and potentially re-sampled, input data manager 113 may preprocess the terminal data to label features, such as event types, service request types (service requests), service action types (incidents), etc. Moreover, input data manager 113 may label additional or other portions/components of the terminal data, such as and by way of example only, with terminal identifiers, dates, times of day, remedial actions taken to resolve failures, incidents of failure, etc. Furthermore, timestamps may be used to label the days when terminals 130 were reported to require service via service tickets in support system 125 and/or the days when terminals 130 were reported to require a technician intervention (incidents) in maintenance system 124. It is to be noted that any terminal failure associated with an incident may be readily identifiable by a specific label along with a remedial action corresponding to that label, which was taken to resolve the failure and bring the corresponding terminal 130 back online.

Input data manager 113 may maintain a set of sampled, re-sampled, labeled, and timestamped historical data for a training period of time and may process this dataset on, for example, a daily basis (to include a current day of terminal data reporting), such that the preprocessed terminal data is available daily for consumption by MLM trainer 114. Thus, data corresponding to a most-recent training period of time as well as any current day of preprocessed terminal data may be made available to MLM trainer 114 for any given day. As used herein, “preprocessed terminal data” includes raw terminal data processed by input data manager 113 to create an output data set, where the output data set includes results that are associated with the sampling, resampling, timestamping (with the service request days and incident days for any failing terminal 130), and labeling (with the features) performed on the terminal data, as well as, any remaining untouched other components of the terminal data. Preprocessed terminal data may be provided as input data to the MLM trainer 114.

In example embodiments, MLM trainer 114 may designate a first portion of the preprocessed terminal data as training data and a second portion of the preprocessed terminal data as testing data. Each type of MLM may then be trained using the same set of training data as input for each type of MLM. Each MLM may then configure itself, based on the features labeled in the input training data, to provide, as output, a terminal failure prediction for each terminal represented by the training data, where each MLM is trained to produce a terminal failure prediction that matches the specific labels in the training data, the labels being the expected output for the given set of corresponding features). In some embodiments, each MLM provides, for each predicted failure, the terminal identifier, the date of the failure (incident date), the service request date, the remedial action date, and the remedial action. In an embodiment, the types of MLMs may include a Long Short-Term Memory (LSTM) recurrent neural network MLM, a decision-tree-based ensemble MLM that uses a gradient boosting framework (such as XGBoost), and a gradient boosting framework MLM that uses tree-based learning (such as LightGBM), or the like. The different types of MLMs may employ supervised, semi-supervised, or unsupervised machine learning algorithms.

In example embodiments, MLM trainer 114 passes the training data as well as the expected output for the training data as input to the different types of MLMs, which then configure themselves to derive respective machine-learning algorithms that generate the expected output when supplied with the labeled feature data. The MLM trainer 114 may then pass the testing data, which as described above, may have been portioned out from the same terminal dataset from which the training data was obtained, to each of the MLMs, which in turn, generate their respective predictions as output. MLM trainer 114 compares the predictions for each MLM to determine its recall (ratio of the total number of correctly predicted failures for the testing data to the known total number of failures in the testing data) and precision (the ratio of the total number of correctly predicted failures for the testing data to the total number of predicted failures (which includes both correctly predicted failures as well as false positives (i.e., incorrectly predicted failures))). A harmonic mean may then be calculated for each of the MLMs as an F1 value/score. The F1 value/score is calculated as 2*((precision*recall)/(precision+recall). The F1 value/score provides a single metric for evaluating the performance of the MLMs, which weights the ratios (precision and recall) in a balanced manner. The higher the F1 value/score is, the better a given MLM is at accurately predicting true failures and the better the MLM is at not predicting false failures for the terminals 130. The F1 value/score is a non-limiting example of a “prediction score” or variants thereof, as that term is used herein.

In example embodiments, production environment manager 115—which may be a third pipeline or a third set of workflows—is invoked after the MLM trainer 114 completes the training session to select the MLM having the highest score for production deployment for the retailer associated with the terminal data. More specifically, in an example embodiment, production environment manager 115 deploys an instance of the selected MLM having the highest score during training to the production environment of the retailer as a production MLM instance for a current period of time. The current period of time may have a configurable duration, e.g., one week.

Input data manager 112 may collect real-time terminal data during a current period of time, perform feature labeling, and optionally, labeling of other components of the terminal data (e.g., terminal identifier), and provide the labeled data to production environment manager 115 on a periodic (e.g., daily) basis. At the end of each day, production environment manager 115 may supply the labeled data as input to the selected MLM instance that is operational within the production environment. Any failure predictions received from the MLM instance may be collected and provided to maintenance system 124 via an API or may be provided through a separate user interface of production environment manager 115 to the retailer using an API. In an embodiment, production environment manager 115 also supplies the current day's worth of labeled terminal data to the MLMs that were not selected for the production environment and retains any predictions made by these non-selected MLMs as candidate predictions made for the current period of time.

At the conclusion of the current period of time, production MLM monitor 117 may obtain the ongoing collection of training data for the current period of time from the input data manager 114 (which may include actual terminal failures and their service requests, incidents, and remedial actions) and compare the actual terminal failures against the predicted failures made during the current period of time by the production MLM instance 116 to calculate, for example, a prediction score (e.g., F1 value/score) of the selected production MLM instance 116 for the current period of time. Production MLM monitor 117 may also calculate prediction scores for the non-selected MLMs over the current period of time based on a comparison of the candidate predictions made by the non-selected MLMs to the actual terminal failures.

Production MLM monitor 117 may then select, as a next production MLM instance 116 for a next period of time, the MLM having the highest score over the current period of time. It should be noted that the MLM instance 116 selected for the next period of time may be the same MLM instance 116 used over the current period of time or may be one of the previously non-selected MLMs. In this manner, system 100 provides a data adaptability capability that evolves over time to changes in patterns of the terminal data, such that an optimal MLM type is selected, for any given period of time, to be the MLM instance 116 for providing predictions within the production environment.

Once a next MLM instance is selected for a next period of time, production MLM monitor 117 may invoke MLM trainer 114 to train the selected MLM instance 116 over the most-recent training period of time. It should be noted the training period of time may be longer than an interval selected for the current period of time. For example, a selected interval for the current period of time and/or the next period of time may be 1 week, while input data manager 113 may select the most-recent training period as the previous 2, 3, or 4 weeks of terminal data. Moreover, in some embodiments, the initial training period of time during which the different types of MLMs are all trained and tested for a first selection of a first production MLM instance 116 may be greater than the most-recent training period of time maintained after the initial training by input data manager 113. In those scenarios in which the MLM instance 116 selected for the production environment for the current period of time is retained for a next period of time, the MLM trainer may not need to separate the preprocessed terminal data for the most-recent training period of time into separate training data and testing data. That is, a selected MLM instance 116 that is being retained for a next period of time may be retrained (trained a second time) on all of the preprocessed training data over the training period of time.

After the MLM trainer 114 performs the retraining of the selected MLM instance, the production environment manager 115 may deploy the retrained selected MLM instance 116 into the production environment of the retailer. At the conclusion of each current period of time, the process of calculating prediction scores for the selected MLM instance 116 and the non-selected MLMs may be iteratively repeated along with the retraining of a new selected MLM instance 116 for a next period of time. In example embodiments, input data manager 113 ensures that preprocessed data of the terminal data is maintained for a most-recent training period of time and that a current day's worth of labeled terminal data is supplied to production environment manager 115. Production MLM monitor 117 may then ensure that an optimal MLM instance 116 is selected for each next period of time. As such, the process of iteratively determining prediction scores of both the production environment MLM instance as well as the non-selected MLM instances for the current period of time in order to determine an optimal MLM instance to select for deployment in the production environment for a next period of time is adaptive to the terminal data and involves continuously re-training optimal selected MLMs 116 instances against actual failures and non-failures.

In an embodiment, 113-117 is provided as a Software-as-a-Service (SaaS) to multiple retailers via their corresponding maintenance systems 124. Here, APIs may be used to enable interaction between the maintenance system 124 and system 100 for the purposes, for example, of maintaining optimal MLM instances 116 within the retailers' production environments during any given interval of time and providing terminal failure predictions to workflows of the maintenance systems 124.

In an embodiment, system 100 maintains and processes each retailer's terminal data separately. In another embodiment, for a given retailer, system 100 maintains and processes the terminal data for each of the retailer's stores separately. For example, a given retailer may be using a first MLM instance 116 in production for a first store and a second different MLM instance 116 in production for a second store. The unique terminal data of each store and/or each retailer can drive predictions for the corresponding deployed MLM instance 116.

In an embodiment, production MLM monitor 117 implements data drift monitoring to detect changes in data schemas for or within the terminal data that can potentially lead to a degradation in prediction scores for the MLMs. This can be done by maintaining metrics for the terminal data over time and can be used to enhance or modify the data input manager 113 to adjust the features and labels for the terminal data. For example, suppose a given type of metric experiences a deviation in value that is higher than a predefined value or outside a given range, a notification may be sent to determine whether one or more features in the terminal data that correspond to the metric are changing such that retraining is needed for the MLMs. As another example, suppose a data schema for the terminal data removes a field or adds a field such that previously captured features are either no longer available in the data or new features are present in the data, then retraining of the MLMs may be needed in these situations as well.

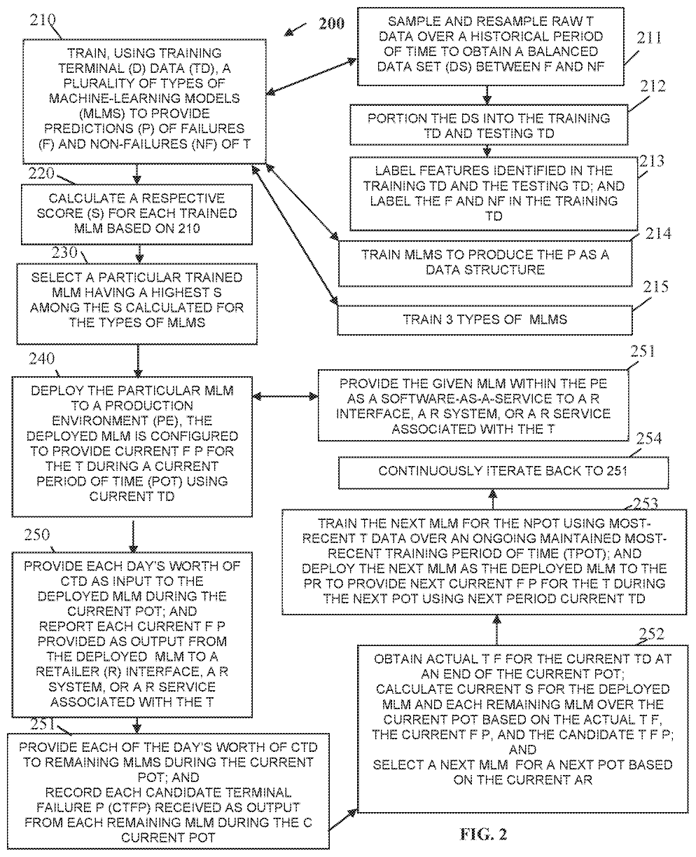

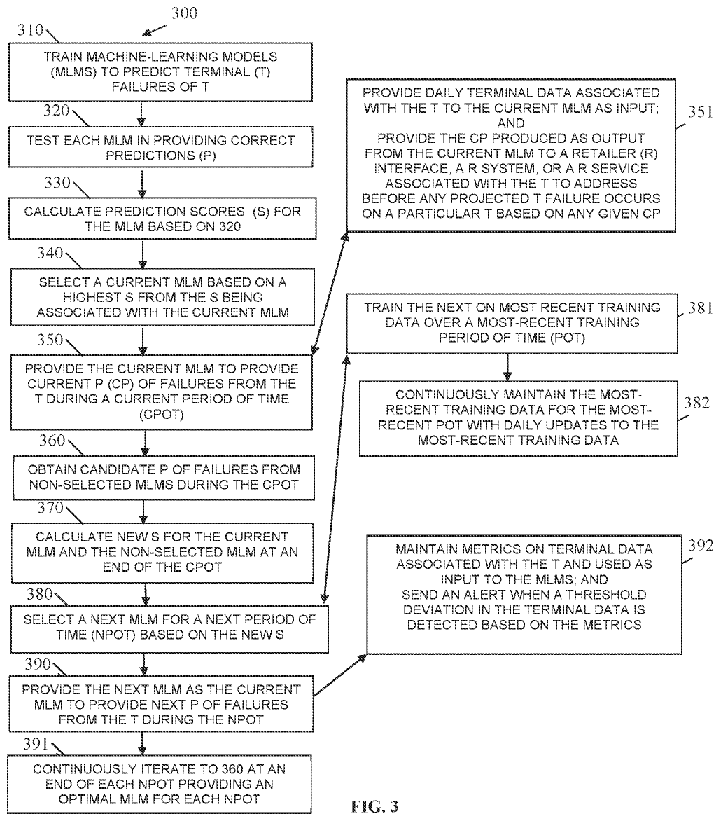

The embodiments of FIG. 1 and other embodiments are now discussed with reference to FIGS. 2 and 3. FIG. 2 is a diagram of a method 200 for predictive maintenance on terminals, according to an example embodiment. The software module(s) that implements the method 200 is referred to as a “predictive terminal failure manager.” The predictive terminal failure manager is implemented as executable instructions programmed and residing within memory and/or another non-transitory computer-readable (processor-readable) storage medium and executed by one or more hardware processors of one or more hardware computing devices. The processor(s) that execute the predictive terminal failure manager may be specifically configured and programmed to process the predictive terminal failure manager. The predictive terminal failure manager may access one or more networks during its processing. The networks can be wired, wireless, or a combination of wired and wireless.

In an embodiment, the devices that execute the predictive terminal failure manager may be hosted in a cloud environment 110 and may include one or more servers or other computing devices located remotely from a retailer's store and potentially operated by a third party. In other embodiments, the devices that execute the predictive terminal failure manager may include one or more servers 110 that internally deploy system 100 at a retailer's store.

At 210, the predictive terminal failure manager trains, using training terminal data, a plurality of types of MLMs to provide predictions associated with failures and non-failures of terminals. In an embodiment, the predictive terminal failure manager is all or some combination of 113, 114, 115, 116, and/or 117.

In an embodiment, at 211, the predictive terminal failure manager samples and resamples raw terminal data over a historical period of time to obtain a balanced data set between the failures and the non-failures of the terminals. In an embodiment of 211, and at 212, the predictive terminal failure manager portions the data set into the training terminal data and testing terminal data.

In an embodiment of 212, and at 213, the predictive terminal failure manager labels features identified in the training terminal data and the testing terminal data. The predictive terminal failure manager may also label the failures and the non-failures in at least the training terminal data.

In an embodiment, at 214, the predictive terminal failure manager trains the MLMs to produce the predictions as a data structure. The data structure comprises terminal identifiers for the terminals projected by each MLM to have a maintenance issue/failure; a type of maintenance issue/failure; a projected calendar date, day of week, or elapsed number days from a current day that each terminal identified by the corresponding terminal identifier is projected to encounter the maintenance issue/failure; and a suggested remedial action needed to resolve the maintenance issue/failure. In some embodiments, each MLM may generate a respective data structure as described above for each terminal predicted fail. Alternatively, the data structure may contain corresponding data for all terminals that the MLM predicts will fail.

In an embodiment, at 215, the predictive terminal failure manager trains different types of MLMs, which may include a first type of MLM such as a LSTM recurrent neural network MLM, a second type of MLM such as a decision-tree-based ensemble MLM that uses a gradient boosting framework, and a third type of MLM such as a gradient boosting framework MLM that uses tree-based learning. In an embodiment, each type of MLM is separately trained on the same set of training terminal data.

At 220, in an embodiment, the predictive terminal failure manager calculates a respective prediction score (e.g., an F1 score) for each trained MLM. This is done by first training each MLM on training terminal data at 210 and then testing each trained MLM. Then a respective score can be calculated for each MLM using the corresponding precision rate and recall rate identified during the testing.

At 230, in an embodiment, the predictive terminal failure manager selects a particular trained MLM having a highest score among the scores calculated at 220 for the types of MLMs. In example embodiments, the trained MLM with a highest F1 score is determined to be an optimal MLM for deployment within a production environment.

At 240, in an embodiment, the predictive terminal failure manager deploys the selected trained MLM (as a production MLM instance 116) to a production environment. The deployed MLM is configured to provide current failure predictions for the terminals during a current period of time using current terminal data.

In an embodiment, the predictive terminal failure manager provides the deployed MLM within the production environment as a SaaS to a retailer interface, a retailer system, or a retailer service associated with the terminals. The predictive terminal failure manager may interact with the corresponding retailer component via an API to obtain the terminal data, provide the current failure predictions to workflows of the component, and maintain an optimal/deployed MLM within the production environment of the retailer.

In an embodiment, at 250, the predictive terminal failure manager provides each day's worth of the current terminal data as input to the deployed MLM during the current period of time. The predictive terminal failure manager reports each current failure prediction provided as output by the deployed MLM to a retailer interface, a retailer system, or a retailer service associated with the terminals.

In an embodiment of 250, and at 251, the predictive terminal failure manager provides each day's worth of current terminal data to remaining non-selected MLMs during the current period of time (i.e., MLMs that were trained and evaluated (210-230) but not deployed to the production environment). In some embodiments, the predictive terminal failure manager records each candidate terminal failure prediction received as output from each remaining MLM during the current period of time.

In an embodiment of 251, and at 252, the predictive terminal failure manager obtains actual transaction failures for the current terminal data at an end of the current period of time. The predictive terminal failure manager may calculate prediction scores for the deployed MLM and for each non-selected MLM over the current period of time based on the actual transaction failures, the current failure predictions, and the candidate terminal failure predictions. The predictive terminal failure manager may then select a next MLM for a next period of time based on the current prediction scores.

In an embodiment of 252, and at 253, the predictive terminal failure manager trains the next MLM for the next period of time using most-recent terminal data over an ongoing maintained most-recent training period of time. The predictive terminal failure manager may then deploy the next MLM to the production environment as the deployed MLM instance to provide failure predictions for the terminals during the next period of time using next period terminal data.

In an embodiment of 253, and at 254, the predictive terminal failure manager continuously iterates back to 261 with the next selected MLM becoming the deployed MLM, the next period of time becoming the current period of time, and the next period terminal data becoming the current terminal data. This ensures that the deployed MLM is an optimal MLM for any given current period of time as judged from the most-recently past current period of time.

FIG. 3 is a diagram of another method 300 for predictive maintenance on terminals, according to an example embodiment. The software module(s) that implements the method 300 is referred to as a “preventive failure manager.” The preventive failure manager may be implemented as executable instructions programmed and residing within memory and/or another non-transitory computer-readable (processor-readable) storage medium and executed by one or more hardware processors of one or more hardware devices. The processor(s) that execute the preventive failure manager may be specifically configured and programmed to process the preventive failure manager. The preventive failure manager may access one or more networks during its processing. The networks can be wired, wireless, or a combination of wired and wireless. The preventive failure manager may represent another and, in some ways, an enhanced processing perspective in relation to that which was described above with respect to the method 200.

In an embodiment, the devices that execute the preventive failure manager may be hosted in a cloud environment 110 and may include one or more servers or other computing devices located remotely from a retailer's store and potentially operated by a third party. In other embodiments, the devices that execute the preventive failure manager may include one or more servers 110 that internally deploy system 100 at a retailer's store. In an embodiment, the preventive failure manager includes all or some combination of 113, 114, 115, 116, 117, and/or method 200.

At 310, in an embodiment, the preventive failure manager trains multiple MLMs to predict terminal failures of terminals. This can be done in any of the manners discussed above with respect to system 100 and/or method 200.

At 320, in an embodiment, the preventive failure manager tests each trained MLM's ability to generate correct predictions. As discussed above with respect to system 100 and/or method 200, terminal data may be portion into training terminal data and testing terminal data.

At 330, in an embodiment, the preventive failure manager calculates prediction scores for the MLMs based on or responsive to 320. That is, the precision and recall rates of the MLMs may be calculated based on the testing at 320. The precision rate and the recall rate of each MLM may then be used to calculate a corresponding F1 score for each MLM.

At 340, in an embodiment, the preventive failure manager selects a current MLM having a highest prediction score from the prediction scores calculated for the set of MLMs. The MLM having the highest F1 score may be identified as an optimal MLM by the preventive failure manager.

At 350, in an embodiment, the preventive failure manager provides the selected MLM to provide current predictions of failures from the terminals during a current period of time. That is, the current MLM may be deployed in a production environment as an optimal MLM to provide the current predictions of terminal failures.

In an embodiment, at 351, the preventive failure manager provides daily terminal data associated with the terminals to the current MLM as input. The preventive failure manager may also provide the current predictions produced as output from the current MLM to a retailer interface, a retailer system, or a retailer service associated with the terminals. This allows the retailer to address the potential failures before any actual failure occurs on a particular terminal based on any given current prediction.

At 360, in an embodiment, the preventive failure manager obtains candidate predictions of failures from non-selected MLMs during the current period of time (i.e., the MLMs trained at 310 and tested at 320 but not selected at 340 based on 330). The preventive failure manager may continue to evaluate each of the MLMs (i.e., the currently selected and deployed MLM and the non-selected MLMs) on the daily terminal data even though only the currently selected MLM provides current predictions of terminal failures within the production environment.

At 370, in an embodiment, the preventive failure manager calculates new prediction scores for the current MLM and for the non-selected MLMs at an end of the current period of time. The preventive failure manager may maintain up-to-date prediction scores (e.g., F1 scores) for the current MLM as well as for the non-selected MLMs at the end of each current period of time.

At 380, in an embodiment, the preventive failure manager selects a next MLM for a next period of time based on the new prediction scores calculated at 370. More specifically, the preventive failure manager may select, for deployment within a production environment for a next period of time, an MLM having a highest prediction score among all MLMs. The selected MLM may be the same MLM as the current MLM or which may be an entirely different MLM. In this manner, at the end of each current period of time, the MLMs are re-evaluated to determine an optimal MLM for a next iteration of the current period of time (i.e., the next period of time).

In an embodiment, at 381, the preventive failure manager trains the MLM selected for the next period of time on most-recent training data over a most-recent training period of time. The optimal MLM for the next period of time may be re-trained on the terminal data associated with the past current period of time and, optionally, on past terminal data spanning a longer period of time. Thus, even though the optimal MLM has a highest F1 score among all MLMs, the optimal MLM's prediction reliability (e.g., F1 score) can nonetheless be improved by re-training the optimal MLM on the associated terminal data used during the past current period of time and, optionally, on historical terminal data spanning a longer period of time.

In an embodiment of 381, and at 382, the preventive failure manager continuously maintains the most-recent training data for the most-recent training period of time with daily updates to the most-recent training data. The most-recent training data for the most-recent training period of time may include the terminal data associated with the current period of time that just passed, and optionally, terminal data that is associated with a longer period of time (i.e., longer than the past current period of time). Thus, the time period associated with re-training a selected MLM may be equal to the interval of time associated with the current period of time or may extend farther into the past beyond the current period of time (i.e., the training time interval may be longer than the interval associated with the current period of time).

At 390, in an embodiment, the preventive failure manager provides the next MLM as the current MLM within a production environment of a retailer associated with the terminals. The current MLM provides predictions of failures of the terminals during the next period of time. The next period of time may include the next interval and the new current period of time.

In an embodiment, at 391, the preventive failure manager continuously iterates back to 360 at an end of each next period of time. During a subsequent iteration, a next selected MLM becomes the currently selected MLM and the next period of time becomes the current period of time. Each currently selected MLM for each current period of time is provided within the production environment as an optimal MLM because that MLM was determined to have the highest F1 value for the prior period of time.

In an embodiment, at 392, the preventive failure manager maintains metrics relating to the terminal data that is used as input to the MLMs. In some embodiments, the preventive failure manager sends an alert when a threshold deviation in the terminal data is detected based on the metrics. This may indicate that the feature labelling in the terminal data needs to be adjusted to avoid data drift for the MLMs. The preventive failure manager may also send an alert or notification when data fields or components associated with a data schema of the terminal data is detected as having been changed based on the metrics or is determined to be trending towards deviations that may be problematic. This allows the retailer or provider of system 100 to detect when the terminal data is drifting such that the features used to originally train the MLMs may be losing their predictive capacity, in which case, the MLMs may need to be retrained based on the drift detected in the terminal data.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, or the like. At least some modules may be combined, or the functionality of the modules may be implemented in software structured in any other convenient manner. Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
training, using training terminal data, a plurality of types of machine learning models (MLMs) to provide predictions of failures and non-failures of terminals;
testing each trained MLM using testing terminal data;
calculating a respective score for each trained MLM based on the testing;
selecting a particular trained MLM having a highest score among the scores calculated for the plurality of types of MLMs; and
deploying the particular trained MLM to a production environment, wherein the deployed MLM is configured to provide current failure predictions for the terminals during a current period of time using current terminal data.

2. The method of claim 1, further comprising:
providing current terminal data as input to the deployed MLM during the current period of time; and
reporting each current failure prediction generated as output by the deployed MLM to a retailer interface, a retailer system, or a retailer service associated with the terminals.

3. The method of claim 2, further comprising:
providing the current terminal data to one or more of the plurality of MLMs that are not currently deployed within the production environment during the current period of time; and
recording each candidate terminal failure prediction received as output from a corresponding one of the one or more MLMs that are not currently deployed within the production environment during the current period of time.

4. The method of claim 3, further comprising:
determining actual terminal failures from the current terminal data at an end of the current period of time;
calculating current scores for the deployed MLM and each of the one or more MLMs not currently deployed within the production environment over the current period of time based on the actual terminal failures, the current failure predictions, and the candidate terminal failure predictions; and
selecting a next MLM for deployment in the product environment for a next period of time based on the current scores.

5. The method of claim 4, further comprising:
training the next MLM for the next period of time using most-recent terminal data maintained over a most recent training period of time; and
deploying the next MLM to the production environment as the deployed MLM to provide failure predictions for the terminals during the next period of time using next period terminal data for the next period of time.

6. The method of claim 5, further comprising:
continuously iterating the providing of current terminal data as input to the deployed MLM during the current period of time, wherein the next period of time transitions to become the current period of time and the next period terminal data transitions to become the current terminal data.

7. The method of claim 1, wherein training further includes sampling and resampling raw terminal data over a historical period of time to obtain a balanced data set between the failures and the non-failures.

8. The method of claim 7, further comprising portioning the balanced data set into the training terminal data and testing terminal data.

9. The method of claim 8, further comprising:
labeling features identified within the training terminal data and the testing terminal data; and
labeling the failures and the non-failures within the training terminal data.

10. The method of claim 1, wherein training further includes training the MLMs to provide each prediction associated with any terminal failure as a data structure comprising, a terminal identifier for the corresponding terminal, a projected date for the corresponding terminal failure, a projected type associated the corresponding terminal failure, and a projected remedial action to perform on the corresponding terminal to resolve the corresponding terminal failure before the corresponding terminal experiences an actual the failure.

11. The method of claim 1, wherein training further includes training three types of MLMs comprising a first type associated with a Long Short-Term Memory (LSTM) recurrent neural network MLM, a second type associated with a decision-tree-based ensemble MLM that uses a gradient boosting framework, and a third type associated with a gradient boosting framework MLM that uses tree-based learning.

12. The method of claim 1, wherein deploying further includes providing the deployed MLM within the production environment as a Software-as-a-Service (SaaS) to a retailer interface, a retailer system, or a retailer service associated with the terminals.

13. A method, comprising:
training machine learning models (MLMs) to predict terminal failures of terminals;
testing a capability of each MLM to provide correct predictions;
calculating respective prediction scores for the MLMs based on the testing;
selecting an MLM having a highest prediction score from the calculated prediction scores;
providing the selected MLM to a deployment environment to provide predictions of failures of the terminals during a current period of time;
obtaining candidate predictions of failures of the terminals from non-selected MLMs during the current period of time;
calculating new prediction scores for the selected MLM and the non-selected MLMs;
selecting a next MLM for a next period of time based on the new prediction scores; and
providing the selected next MLM to the deployment environment to provide predictions of failures from the terminals during the next period of time.

14. The method of claim 13, further comprising, continuously iterating to the obtaining at an end of each next period of time and providing the selected next MLM as an optimal MLM for the predictions for each next period of time.

15. The method of claim 13, further comprising:
maintaining metrics on terminal data associated with the terminals; and
sending an alert when a threshold deviation in the terminal data is detected based on the metrics.

16. The method of claim 13, wherein providing the selected MLM to the deployment environment further includes providing daily terminal data associated with the terminals to the selected MLM as input, and providing the predictions produced as output by the selected MLM to a retail interface, a retail system, or a retail service associated with the terminals before any projected terminal failure occurs on any particular terminal based on any given prediction.

17. The method of claim 13, wherein selecting the next MLM further includes training the next MLM on most-recent training data over a most-recent training period of time.

18. The method of claim 17, further comprising continuously updating the most-recent training data for the most-recent training period of time.

19. A system, comprising:
a service comprising at least one processor and a non-transitory computer-readable storage medium, the non-transitory computer-readable storage medium comprising executable instructions that when provided to or obtained by the at least one processor from the non-transitory computer-readable storage medium cause the at least one processor to perform operations, comprising:
obtaining historical training data associated with terminal failures and non-failures of terminals;
sampling and resampling the historical training data to generate a balanced data set of failures and non-failures;
labeling features within the data set, the features comprising terminal identifiers for the terminals, the failures, the non-failures, dates for the failures, and remediation actions taken for the failures;
portioning the data set into training data and testing data;
training a plurality of machine learning models (MLMs) based on the training data, the plurality of MLMs including two or more types of MLMs;
testing the plurality of types of MLMs based on the testing data;
calculating a respective score for each type of MLM based on the testing;
selecting an MLM having a highest score;
deploying the selected MLM into a production environment of a retailer as a deployed MLM to provide daily predictions on potential terminal failures over a current period of time;
calculating new scores for the deployed MLM and non-deployed MLMs not selected for operation within the production environment at the end of the current period of time;
selecting a next MLM having a highest score for a next period of time;
training the next selected MLM on most-recent training data over a most-recent training period of time;
deploying the next MLM into the production environment as the deployed MLM to provide the daily predictions during the next period of time; and
continuously iterating to recalculate the scores at the end of each next period of time.

20. The system of claim 19, wherein each terminal is a self-service terminal, an automated teller machine, a point-of-sale terminal, or a kiosk.
